(19) United States
(12) Patent Application Publication
(10) Pub. No.: US 2026/0370589 A1
(43) Pub. Date: Nov. 19, 2026

(54) METHOD FOR ROUTING MESSAGES IN A MESH NETWORK

(71) Applicant: Orange, Issy-Les-Moulineaux (FR)

(72) Inventors: Philippe SURBAYROLE, Chatillon Cedex (FR); Apostolos KOUNTOURIS, Chatillon Cedex (FR)

(21) Appl. No.: 19/143,361

(22) PCT Filed: Dec. 20, 2023
(86) PCT No.: PCT/EP2023/086942

§ 371 Date: Jun. 25, 2025

(30) Foreign Application Priority Data
Dec. 26, 2022 (FR) FR2214497

(51) Int. Cl. H04L 45/02; H04L 45/00

(52) U.S. Cl. CPC H04L 45/02; H04L 45/20

(57) ABSTRACT

This disclosure relates to a routing method for routing a message via nodes in a mesh network, wherein the message comprises routing rationalization data (RoutingData), the method being implemented by a node in the mesh network, and comprising: upon receiving (E1) said message, selecting (E2), at least on the basis of said routing rationalization data and of a network topology, a node to which to transmit said received message.

### CROSS-REFERENCE TO RELATED APPLICATIONS

This application claims is filed under 35 U.S.C. § 371 as the U.S. National Phase of Application No. PCT/EP2023/086942 entitled “METHOD FOR ROUTING MESSAGES IN A MESH NETWORK” and filed Dec. 20, 2023, and which claims priority to FR2214497 filed Dec. 26, 2022, each of which is incorporated by reference in its entirety.

### BACKGROUND

### Field

This disclosure relates to the field of message routing in a network, and in particular to message routing in a mesh network which makes use of a flooding transmission mode.

### Description of the Related Technology

In IoT (Internet of Things) networks, it is known to use mesh networks. In a mesh network, nodes are connected peer-to-peer without a central hierarchy, and each node can receive, send, and retransmit a message. The implementation of a mesh network makes it possible to increase network robustness by avoiding sensitive points where network operation may be disrupted in the event of a failure. Indeed, in a mesh network, if a node fails, the message can be transmitted via an alternative route.

Within such a mesh network, messages can be transmitted in flooding mode. Flooding involves flooding the network with messages in the hope that they will arrive at their destination. This technique can be used for message routing or for route discovery within the network, for example using the AODV (Ad hoc On Demand Distance Vector) protocol. This network flooding technique eliminates the need to maintain routing tables and allows for responsiveness to changes in network architecture, such as the addition of a new node, the use of mobile nodes, or in the event of a failure and/or attack.

However, in a mesh network, the flooding transmission mode has the disadvantage of encouraging network congestion and can have a significant energy impact. Routing methods are sought that are less energy-intensive and that reduce the risk of network saturation.

### SUMMARY

This disclosure improves the situation.

A routing method is proposed for routing a message via nodes of a mesh network, wherein the message comprises routing rationalization data. The method is implemented by a node of the mesh network, and comprises:

upon receiving said message, selecting, at least on the basis of said routing rationalization data and of a network topology, a node to which to transmit said received message.

The mesh network is also referred to as the “main network” hereinafter.

“Topology” of the network is understood to mean data concerning the relative positions of the nodes in the network, as well as data concerning the respective capabilities of these nodes. Thus, access to this topology data makes it possible to determine how network elements are interconnected (nodes to each other or nodes to specific networks that are different from the main network). The capabilities of these nodes may thus characterize whether a node is connected to a network different from the main network (such as a router via a satellite network for example), or whether a node is mobile (for example a mobile terminal capable of relaying messages to target nodes when it is within the radiofrequency range of these targets).

In particular, nodes configured to select a node to which to transmit said received message on the basis of the routing rationalization data and of the network topology, may also be referred to hereinafter as “routing-shortcut nodes”. By selecting the node to which to transmit the received message, the routing-shortcut node may thus adapt the transmission mode for the method on the basis of said routing rationalization data. The routing-shortcut node implements a transmission mode for the message, hereinafter referred to as “shortcut transmission mode”, when the routing-shortcut node selects the node to which to transmit the received message. The nodes of the main network which are other than routing-shortcut nodes will be referred to as “conventional nodes”.

Hereinafter, “conventional node” is understood to mean the nodes that are not able to read said routing rationalization data and/or that are not able to select a node to which to transmit the received message. It will be understood that the number of conventional nodes in the main network is generally greater than the number of routing-shortcut nodes.

Conventional nodes implement a message transmission mode that is referred to hereinafter as “conventional”, corresponding in particular to the main mode for transmitting messages in a mesh network to nearby nodes (within radiofrequency range, for example), typically “flooding” mode.

Some of the nodes referred to hereinafter as “directional-routing” nodes may also implement a transmission mode referred to hereinafter as “directional”, which may consist in particular of a geographic routing of messages. Geographic routing of messages is carried out in particular according to the geographical location data of the nodes and the destination of the messages, and directional transmission mode allows spatially directing the transmission of messages towards the destination of the node receiving the message.

Routing-shortcut nodes are advantageously able to transmit the message using at least two transmission modes, possibly combined: shortcut transmission mode and directional transmission mode.

“Routing rationalization data” is understood here to mean data present in some of the received messages and read by a particular node (typically a routing-shortcut node) upon receiving this message, in order to rationalize the routing of this message. This rationalization may consist of limiting the number of hops to be made in transmitting the received message, for example by choosing to route the message:

to a routing-shortcut node (for example using the capabilities of a different network, such as a satellite network) in order to transmit the message more quickly (i.e. in fewer hops) to the destination node, and/or to a node located in the “right direction” towards the destination node (in directional mode).

The rationalization data may thus comprise data concerning the geographical destination of the message, and/or a limited number of hops to reach this destination. The term “number of hops” refers to a number of successive retransmissions of the message by nodes.

For example, in one implementation, the presence of rationalization data, when it designates a maximum number of hops in order to reach the destination node of the message, may, for a routing-shortcut node, involve searching for retransmission nodes with specific routing capabilities (for example, a node capable of routing the message to a satellite network with few intermediate nodes before reaching the destination node).

Limiting the number of hops of a message in a network offers the particular advantage of not saturating the network. For example, the message comprising rationalization data with a limited number of hops may be ignored and no longer be routed if the limited number of hops is reached. Such an implementation may advantageously be implemented for redundant messages where some transmissions may not be successful, such as messages from sensors regularly transmitting a measurement message. In that case, if a message containing a measurement does not reach its recipient, a subsequent message with another measurement may still satisfy the needs of its recipient node, one goal of this implementation being to avoid saturating the network with messages that may sometimes be redundant.

Thus, routing-shortcut nodes ensure, at the minimum, a limited number of hops for routing a message containing rationalization data. Of course, a distance between the node sending the message and the node receiving the message may be taken into account in defining a reasonable limit number of hops (the greater this distance, the greater the limit number of hops).

Furthermore, to reduce the number of hops, the message should be routed by nodes that are generally oriented towards the destination node. The rationalization data may therefore also include geographical destination data concerning the recipient node, so that the routing-shortcut nodes can use directional-routing nodes to transmit the message to the destination node. Moreover, in one embodiment, some or all of the routing-shortcut nodes are directional-routing nodes. However, it may be that a current node has to arbitrate an optimization between transmitting the message to a directional-routing node or to a routing-shortcut node. In such a situation, the current node determines, based on the network topology (positions of the nodes but also capacities of these nodes), the next node to which to transmit the message. For example, rather than choosing a node oriented in the right direction towards the recipient node, it is possible to choose a node that is not necessarily “properly oriented” but which has a fast transmission capacity (with few hops, for example via a satellite or LIFI network).

Routing adapted to the message is thus proposed, in particular when the message requires a limited number of hops, notably based on the distance between the message and a geographical destination of the message, by making use of the routing rationalization data. The use of routing rationalization data makes it possible in particular to estimate whether the transmission of the message needs a shortcut so that the message can reach its destination, based on a limited number of hops for example, and adapting the transmission mode accordingly for the message.

Consequently, the method advantageously makes it possible to implement a shortcut transmission mode for messages when they are transmitted to routing-shortcut nodes, and thus to improve transmission for messages that have to travel a greater distance or that have a limited number of hops. This makes it possible, on the one hand, to limit network saturation by reducing the ripple effect, and on the other hand, to limit consumption by the various network elements and therefore to reduce the energy impact of message transmission. The method finds a particular application in the field of IoT (“Internet of Things”) networks that are wide area networks without centralization.

In one embodiment, the node selected to receive the message may advantageously be a routing-shortcut node. Preferably, the node to which the message is transmitted is a routing-shortcut node, or, failing that, a directional-routing node if no more routing-shortcut nodes are present until the destination node, or, failing that, a conventional node (for example, if the destination node itself is a conventional node or is preceded by at least one conventional node, in order to be able to finalize transmission of the message).

In one embodiment, the routing rationalization data may comprise an indication of a limitation on a number of hops to be provided for transmission of the message, for example a hop count threshold. More specifically, the method may comprise selecting the node to which to transmit the message when the number of remaining hops for the message is less than or equal to the hop number threshold. In other words, a message arriving at one of the routing-shortcut nodes may be retransmitted via the shortcut transmission mode if the number of remaining hops is less than or equal to the hop count threshold; otherwise the message is not retransmitted via the shortcut transmission mode. Thus, if the message has a sufficiently high number of hops, it may possibly not be transmitted using shortcut transmission mode all the way, end-to-end, but for example may be transmitted using the directional or even conventional transmission mode.

In one embodiment, the routing rationalization data may comprise geographical destination data for the message. “Geographical destination data” is understood to mean data which allows defining the spatial location of a destination of the message. The use of geographical destination data advantageously makes it possible to perform directional routing of messages, and thus to orient the transmission of messages in the direction of the destination. “Direction” is understood to mean a spatial direction between the geographical locations concerned.

In one embodiment, a geographical location is advantageously associated with each of the nodes. Each of the nodes in the main network knows its geographical location. The geographical location of each of the nodes may comprise spatial coordinates of a point associated with the node, for example a set of three-dimensional coordinates of said point. Each of the sets of three-dimensional coordinates may be associated with a radius of uncertainty around this point. Each of the nodes may comprise means for determining its location.

Advantageously, when the routing rationalization data comprises geographical destination data, selecting a node to which to transmit the message may be carried out on the basis of said geographical destination data of the message. In particular, a geographical distance may be defined between the geographical location of the routing-shortcut node and the geographical destination of the message. The method may comprise deciding to select a node to which to transmit the message on the basis of said geographical distance. More specifically, the method may comprise deciding to select a node to which to transmit the message when said geographical distance is greater than or equal to a first distance threshold. Thus, if the message is spatially close to its destination, the message may travel onwards not by shortcut transmission mode, but by directional transmission mode (or even conventional as explained above).

In one embodiment, when a node to which to transmit the received message is selected, the method may comprise adjusting a number of remaining hops of the message, for example decreasing the number of remaining hops of the message by at least one. The method may comprise setting the number of remaining hops of the message to a predefined value, for example to one or two remaining hops if the latest node to relay the message is close to the destination node. This features allows stopping, for example, unnecessary propagation of the message, in particular if the message has already benefited from shortcut transmission mode.

In one embodiment, said routing-shortcut nodes comprise additional means of communication in comparison to other nodes of the main network.

According to a first embodiment, when the network topology allows the node receiving the message to communicate with a routing server, selecting a node to which to transmit the received message advantageously comprises transmitting the message to the routing server, in particular a centralized routing server, which is capable of selecting the node to which to transmit the received message and of retransmitting the received message to said selected node. The selected node receiving the message will be able to process the message as if it came from the main network.

Optionally, in the first embodiment, the method may comprise an encapsulation by the routing-shortcut node of the entire message, i.e. the message data as well as the message routing data, in the form of a container message, and a transmission of said container message to the routing server. The method may then comprise a processing of said container message by the routing server and a retransmission thereof to the selected node. The selected node receiving the message is able to extract the message from said container message and retransmit it in the main network.

Optionally, in the first embodiment, said routing-shortcut nodes may comprise additional software and/or hardware communication means in order to enable communication between said routing-shortcut nodes and the routing server. Said communication means may be wired, for example, or radiofrequency-based.

According to a second embodiment, when the network topology allows the node receiving the message to communicate via another network, i.e. a network other than the main network, selecting a node to which to transmit the received message advantageously comprises transmitting the received message to the selected node via said other network. The selected node receiving the message will be able to process the message as if it came from the main network. Said other network preferably consists of a network having a greater geographical range than the main network.

Optionally, in the second embodiment, the method may comprise a consultation of a routing table by the routing-shortcut node in order to establish a route to the selected node via said other network; in particular, the routing table lists the nodes of said other network as well as the associated routes. Said routing-shortcut node may comprise the routing table, or may be able to consult the routing table. Consequently, said routing-shortcut node is able to find a route for transmitting the message via said other network, based on the routing table.

Optionally, in the second embodiment, the method may comprise an encapsulation by the routing-shortcut node of the entire message, i.e. the message data as well as the message routing data, in the form of a container message, and a transmission of said container message to the selected node. The selected node receiving the message is able to extract the message from said container message and retransmit it in the main network.

The routing table may comprise geographical location data associated with each of the nodes of said other network. The routing table is then advantageously geographical, thus allowing the routing-shortcut node to associate the geographical location information of said nodes with the nodes of said other network.

Optionally, in the second embodiment, said routing-shortcut nodes may comprise additional software and/or hardware communication means in order to enable communication between said routing-shortcut nodes via said other network. Said communication means may be, for example, satellite, LTE, or LIFI type means.

According to a third embodiment, the routing rationalization data comprises the geographical destination data, and the method advantageously comprises obtaining respective current location data of at least two of said routing-shortcut nodes, and transmitting the message from a sending node to the receiving other node of said two routing-shortcut nodes, if a distance between the respective current locations of the sending and receiving nodes is less than a second distance threshold. The receiving node corresponds in particular to a node closer to the destination of the message than the sending node. Preferably, the receiving node is covered by the geographical destination of the message.

In this third embodiment, selecting a node to which to transmit the received message advantageously comprises said routing-shortcut node storing the message and then transmitting said received message to the selected node, when the distance between the respective current locations of the sending and receiving nodes is less than the second distance threshold. This feature advantageously allows the routing-shortcut node that received the message to hold it temporarily and forwarding the message when the criterion of the second distance threshold is reached. This further allows limiting the number of hops of the message.

Advantageously, the method may comprise storing the received message in a table of received messages upon reception by the routing-shortcut node, as long as the node is at a greater distance from the selected node than the second distance threshold. Optionally, additional constraint parameters concerning the message transmission may be stored in the table of received messages.

Optionally, in the third embodiment, at least some of said routing-shortcut nodes from which the current location data is obtained, are mobile nodes. Mobile nodes are understood to mean nodes that can move about geographically.

Advantageously, said mobile node stores the received message in the table of received messages upon reception, and selects the node to which to transmit the received message when said mobile node is at a distance from the geographical destination of the message that is less than the second distance threshold. Thus, the mobile node may advantageously store the message, and forward the message when the mobile node draws sufficiently close to the geographical destination. If the mobile node does not satisfy the second distance threshold criterion, or other additional parameters restricting propagation of the message are met, the message may be deleted from the table of received messages.

Optionally, in the third embodiment, selecting the node to which to transmit the received message may comprise consulting a location table of the mobile node which lists geographical locations of the mobile node, for example corresponding to times of reception and/or transmission of messages, and/or at regular time intervals. This allows the mobile node to anticipate the geographical locations for the reception and transmission of messages, and the recurring geographical locations of the mobile node. For example, when the mobile node makes a trip regularly, this allows the mobile node to anticipate the geographical locations where it can forward the message.

It is understood that the first, second, and third embodiments may be combined with each other. For example, in a single network, some of the nodes may implement the first embodiment, others the second embodiment, and the third embodiment may be implemented by mobile nodes in the network. If necessary, the routing-shortcut node may select a node to which to transmit the message, according to the most appropriate transmission mode.

According to another aspect, a node of a network is provided for implementing the method as described above.

According to another aspect, a computer program is provided comprising instructions for implementing all or part of a method as defined herein when this program is executed by a processor. According to another aspect, a non-transitory computer-readable storage medium is provided on which such a program is stored.

### BRIEF DESCRIPTION OF THE DRAWINGS

Other features, details and advantages will become apparent from reading the detailed description below, and from analyzing the attached drawings, in which:

FIG. 1 shows an example of a network of nodes for implementing the above method, according to one embodiment.

FIG. 2 shows an example of steps of the method as defined above, according to one embodiment.

FIG. 3 shows an example of a network of nodes for implementing the above method, according to one embodiment.

FIG. 4 shows an example of a network of nodes for implementing the above method according to a first embodiment.

FIG. 5 shows an example of a network of nodes for implementing the above method according to a second embodiment.

FIG. 6 shows an example of a network of nodes for implementing the above method according to a third embodiment.

FIG. 7 schematically illustrates a node for implementing the above method according to one embodiment.

### DETAILED DESCRIPTION OF CERTAIN ILLUSTRATIVE EMBODIMENTS

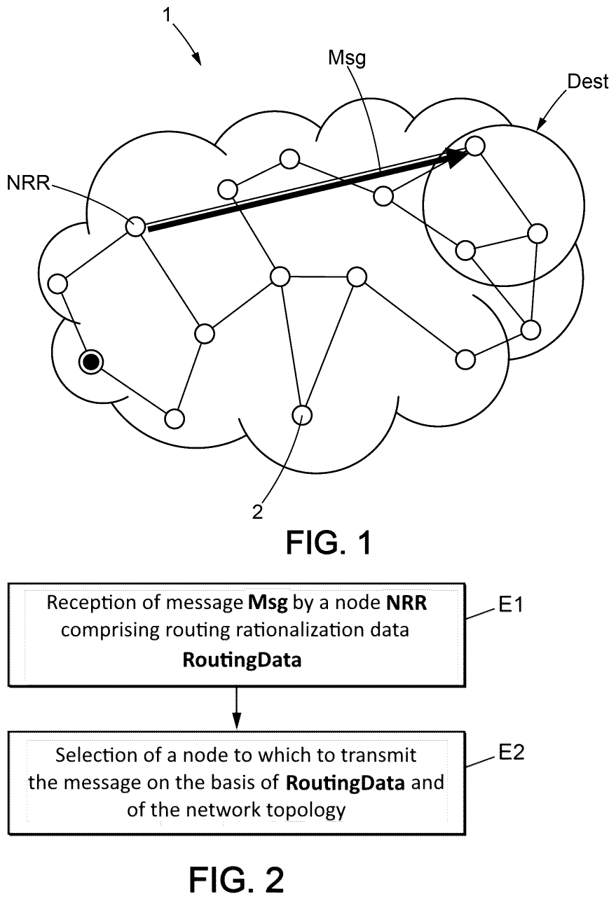

Reference is now made to FIG. 1 which schematically shows a network 1, hereinafter referred to as the main network, the main network 1 having nodes 2, also conventionally referred to as “hosts”. The main network is a mesh network, in particular a “crowd network” or a “disaster network”. In a mesh network, the nodes are connected peer-to-peer with no central hierarchy, each of the nodes being able to receive, send, and retransmit a message. The implementation of a mesh network makes it possible to increase network robustness by avoiding sensitive points where network operation may be disrupted in the event of a failure. Indeed, in a mesh network, if a node fails, the message can be transmitted via an alternative route.

Furthermore, within the main network, messages may be transmitted in flooding mode. In this transmission mode, a sending node sends a message without specifying the receiving node. Any listening node can thus receive the message and must process it. The message can then be forwarded in a similar manner. Message retransmission stops when the receiving node matches the specified destination node(s), or if other constraint parameters are met, for example if a maximum hop count for the message is reached.

Alternatively, messages may be transmitted using a point-to-point mode, commonly referred to as “peer-to-peer”. In this message transmission mode, a message is sent by a sending node but the addresses of the destination node(s) are specified. Any listening node can thus ignore the message if it is not included in the destination node(s). In peer-to-peer mode, the routes are predefined. The main network must then provide seamless connections, or, alternatively, alternate routes may be provided.

Our particular interest concerns the routing of messages in such a network 1.

According to one aspect, this disclosure relates to a routing method for routing a message Msg, also referred to as a packet, via nodes of the main network 1. The message Msg is conventionally composed of “payload” data corresponding to the content of the message to be transmitted, and “routing data” which allows managing the routing of the message in the main network. More precisely, the message is routed from a source to a destination Dest. The “source” of the message may correspond to a node of the main network, or to an entity connected to one of the nodes of the main network and requesting that said node transmit the message. For example, a user may connect to a node through a smart phone interface. “Destination” is understood to mean one or more destination nodes or a geographical destination that may cover one or more destination nodes.

Of more particular interest here is the message's routing data. The message comprises routing rationalization data. The routing rationalization data may comprise message destination data and/or a limited number of hops to reach this destination. The message destination data may be geographical destination data for the message. “Geographical destination data” is understood to mean data which allows defining the spatial location of a destination of the message.

In particular, the number of hops corresponds to the number of times the message is retransmitted by a network node. The use of routing rationalization data according to the number of hops makes it possible in particular to estimate whether the transmission of the message needs a shortcut so that the message can reach its destination.

This disclosure aims in particular to propose routing adapted to the message, in particular when the message has a limited number of hops and/or based on the distance between the message and the geographical destination of the message.

FIG. 2 shows a schematic diagram of the method implemented by a node of the mesh network, referred to as a routing-shortcut node, and comprising, upon receiving E1 said message, selecting E2, at least on the basis of said routing rationalization data and of a network topology, a node to which to transmit said received message.

Consequently, the method according to this disclosure advantageously makes it possible to implement a shortcut transmission mode for messages when they are transmitted to routing-shortcut nodes, and thus to improve transmission for messages that have to travel a greater distance or that have a limited number of hops. This makes it possible, on the one hand, to limit network saturation by reducing the ripple effect, and on the other hand, to limit consumption by the various network elements and therefore to reduce the energy impact of message transmission. Said method finds a particular application in the field of IoT (Internet of Things) networks that are wide area networks without centralization.

Furthermore, the node selected to receive the message may advantageously be a routing-shortcut node. Preferably, the node to which the message is transmitted is a routing-shortcut node, or, failing that, a directional-routing node if no more routing-shortcut nodes are present until the destination node, or, failing that, a conventional node (for example, if the destination node itself is a conventional node or is preceded by at least one conventional node, in order to be able to finalize transmission of the message).

Optionally, when a node to which to transmit the received message is selected, the method may comprise adjusting a number of remaining hops of the message, in particular decreasing the number of remaining hops of the message by at least one. The method may comprise setting the number of remaining hops of the received message to a predefined value, for example to one or two remaining hops. This feature allows stopping unnecessary propagation of the message if the message has already benefited from shortcut transmission mode.

Furthermore, in the context of geographical message routing, a geographical location may advantageously be associated with each of the nodes. Each of the nodes in the main network knows its geographical location. The geographical location of each of the nodes may comprise spatial coordinates of a point associated with the node, for example a set of three-dimensional coordinates of said point. Each of the sets of three-dimensional coordinates may be associated with a radius of uncertainty around this point. Each of the nodes may comprise means for determining its location.

When the routing rationalization data indicates a limitation on the number of hops to be provided for transmission of the message, for example a hop count threshold, the node to which to transmit the received message may be selected based on the number of hops. More specifically, the method may comprise selecting the node to which to transmit the received message when the number of remaining hops for the received message is less than or equal to the hop count threshold. In other words, a message arriving at one of the routing-shortcut nodes may be retransmitted via the shortcut transmission mode if the number of remaining hops is less than or equal to the hop count threshold; otherwise the message is not retransmitted via the shortcut transmission mode. Thus, if the message has a sufficiently high number of hops, it will not use the shortcut transmission mode but may be transmitted using the transmission mode implemented by the conventional nodes.

When the routing rationalization data comprises geographical destination data, a node to which to transmit the received message may be selected on the basis of said geographical destination data of the message. The geographical destination data may comprise a destination point having spatial coordinates, possibly with an associated tolerance radius. The destination node(s) then correspond to the nodes located within the tolerance radius around the destination point.

In particular, a geographical distance may be defined between the geographical location of the routing-shortcut node and the geographical destination of the message. The method may comprise deciding to select a node to which to transmit the received message on the basis of said geographical distance. More specifically, the method may comprise deciding to select a node to which to transmit the received message when said geographical distance is greater than or equal to a first distance threshold. In other words, a message arriving at one of the routing-shortcut nodes may be forwarded via the shortcut transmission mode if said geographical distance is greater than or equal to the first distance threshold; otherwise the message is not forwarded via the shortcut transmission mode. Thus, if the message is spatially close to its destination, the message will not travel onwards by the shortcut transmission mode, but by the transmission mode implemented by the conventional nodes.

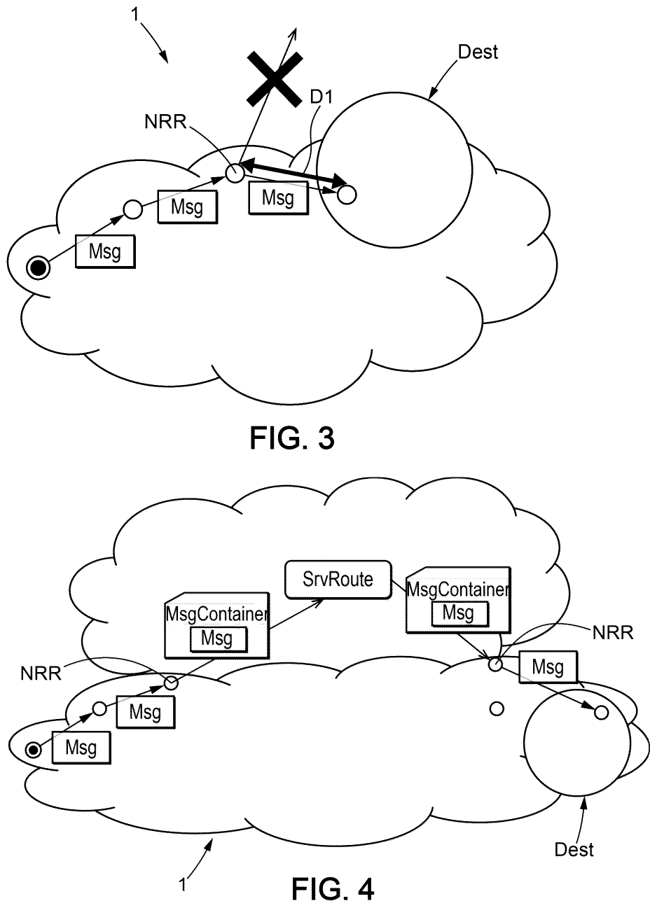

For example, FIG. 3 illustrates a configuration in which a message arriving at a routing-shortcut node NRR is not forwarded via the shortcut transmission mode because the routing-shortcut node is at a geographical distance D1 that is less than said first distance threshold.

Furthermore, the routing-shortcut nodes may have additional software and/or hardware means in comparison to conventional nodes, enabling the routing-shortcut node to offer routing functionality with a greater “range” than conventional nodes. “Greater range” is understood to mean that the routing-shortcut nodes have communication means with a greater geographical range, either because these nodes are able to communicate with each other over a greater geographical distance than an average distance between the conventional nodes of the main network 1, or because these nodes are mobile and consequently cover a greater geographical distance.

Note that the main network may have no knowledge of said additional means used, the transfer of the message being done on an ad hoc basis when it arrives at one of the routing-shortcut nodes which may then decide to transmit the message via a shortcut transmission mode or may not.

FIG. 4 illustrates an example of a main network according to a first embodiment in which, when the network topology allows the node receiving the message to communicate with a routing server, selecting a node to which to transmit the received message advantageously comprises transmitting the received message to the routing server SrvRoute, in particular a centralized routing server, which is able to select the node to which to transmit the received message and to retransmit the received message to the selected node. The selected node receiving the message will be able to process the message as if it came from the main network 1.

In addition, the method may comprise an encapsulation by the routing-shortcut node of the entire message, i.e. the message data as well as the message routing data, in the form of a container message MsgContainer, and a transmission of the container message MsgContainer to the routing server SrvRoute. The method may then comprise a processing of the container message MsgContainer by the routing server SrvRoute and a retransmission thereof to the selected node. The selected node receiving the message is able to extract the message from the container message MsgContainer and retransmit it in the main network 1.

The routing server SrvRoute is, in particular, able to transfer the message to the configured node closest to the destination Dest of the message, in particular to the geographical destination of the message when the routing rationalization data includes the geographical destination data.

The routing server SrvRoute may further decide to transmit the message, or not transmit it, in which case the message will be ignored by the routing server SrvRoute.

Said routing-shortcut nodes may comprise additional software and/or hardware communication means in order to enable communication between said routing-shortcut nodes and the routing server SrvRoute. Said communication means may be wired, for example, or radiofrequency-based.

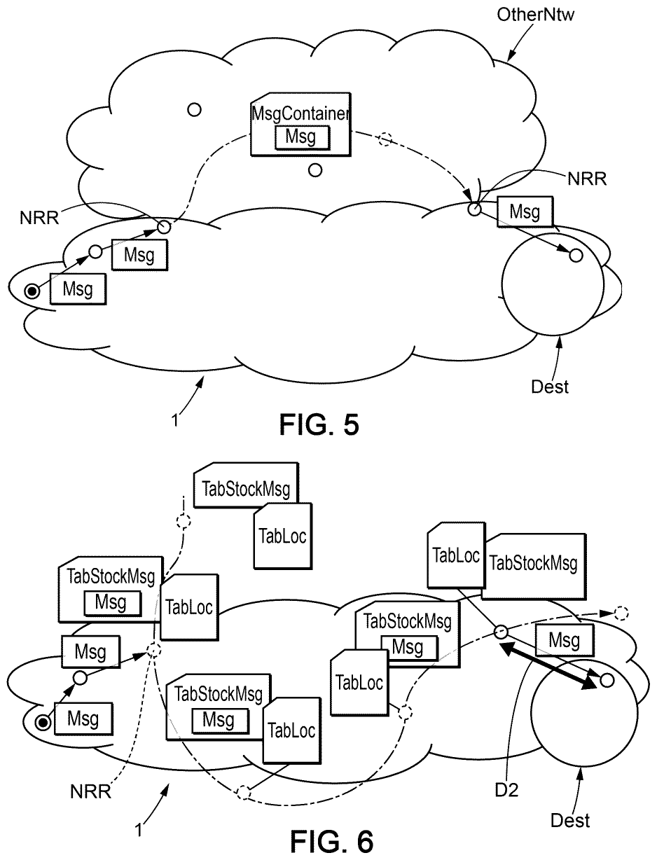

FIG. 5 illustrates an example of a main network according to a second embodiment in which, when the network topology allows the node receiving the message to communicate via another network, i.e. a network other than the main network, selecting a node to which to transmit the message advantageously comprises transmitting the message to the selected node via said other network OtherNtw, referred to as the second network hereinafter. The selected node receiving the message will be able to process the message as if it came from the main network 1.

The second network OtherNtw preferably consists of a network having a greater geographical range than the main network 1. Greater range is understood to mean that the geographical distance between two neighbouring nodes of said second network is, on average, greater than the geographical distance between two neighbouring nodes of the main network 1.

Furthermore, the method may comprise a consultation by the routing-shortcut node in order to establish a route to the selected node via the second network OtherNtw, the routing table listing in particular the nodes of the second network as well as the associated routes. Said routing-shortcut node may comprise the routing table, or may be able to consult the routing table. Consequently, said routing-shortcut node is able to find a route for transmitting the message via the second network OtherNtw, based on the routing table. For example, the routing-shortcut node may transmit the message directly to another node of the main network or via other nodes of the second network OtherNtw.

More specifically, the method may comprise an encapsulation by the routing-shortcut node of the entire message, i.e. the message data as well as the message routing data, in the form of a container message MsgContainer, and a transmission of the container message MsgContainer to the selected node. The selected node receiving the message is able to extract the message from the container message MsgContainer and retransmit it in the main network 1.

The routing table may comprise geographical location data associated with each of the nodes of said other network. The routing table is then advantageously geographical, thus allowing the routing-shortcut node to associate the geographical location information of said nodes with the nodes of the second network.

Said routing-shortcut nodes may comprise additional software and/or hardware communication means in order to enable communication between said routing-shortcut nodes via the second network OtherNtw. Said communication means may be, for example, satellite, LTE, or LIFI type means.

FIG. 6 illustrates an example of a main network according to a third embodiment. In this third embodiment, the routing rationalization data comprises the geographical destination data of the message. The method advantageously comprises obtaining respective current location data of at least two of said routing-shortcut nodes NRR, and transmitting the message from a sending node to the receiving other node of said two routing-shortcut nodes NRR, if a distance D2 between the respective current locations of the sending and receiving nodes is less than a second distance threshold. The node receiving the message is able to process the message as if it originated from the main network 1.

The receiving node may correspond in particular to a node closer to the destination Dest of the message than the sending node. Preferably, the receiving node is covered by the geographical destination of the message.

In this third embodiment, selecting a node to which to transmit the received message advantageously comprises said routing-shortcut node storing the received message and then transmitting said received message to the selected node, in particular to one of the NRR configured nodes, when distance D2 between the respective current locations of the sending and receiving nodes is less than the second distance threshold. This feature advantageously allows the routing-shortcut node that received the message to hold it temporarily and to forward the message when the criterion of the second distance threshold is reached. This further allows limiting the number of hops of the message.

In particular, the method may comprise storing the received message in a table of received messages TabStockMsg upon reception by the routing-shortcut node, as long as said node is at a greater distance from the selected node than the second distance threshold. Optionally, additional constraint parameters concerning the message transmission may be stored in the table of received messages.

At least some of the routing-shortcut nodes from which the current location data is obtained, may preferably be mobile nodes. Mobile nodes are understood to mean nodes that can move about geographically. The mobile node may thus advantageously store the message, and forward the message when the mobile node draws sufficiently close to the geographical destination. If the mobile node does not satisfy the second distance threshold criterion, or other additional parameters restricting propagation of the message are met, the message may be deleted from the table of received messages TabStockMsg.

Furthermore, selecting the node to which to transmit the received message may comprise consulting a location table TabLoc of the mobile node which lists geographical locations of the mobile node, for example corresponding to times of reception and/or transmission of messages, and/or at regular time intervals. This allows the mobile node to anticipate the geographical locations for the reception and transmission of messages, and the recurring geographical locations of the mobile node. For example, when the mobile node makes a trip regularly (for example if the mobile node corresponds to a bus line), this allows the mobile node to anticipate the geographical locations where it can forward the message.

Furthermore, additional constraint parameters may be implemented in order to influence how the transmission of said message is controlled. These additional constraint parameters may apply to any of the embodiments according to this disclosure, described above.

When the message comprises a number of hops NbHop, the node may decide to transmit or not transmit the message, depending on the number of hops. For example, when the number of hops NbHop is initialized to 0, the number of hops may be compared to a maximum number of hops NbHopMax, for example carried by the node or directly in the message. As long as the number of hops NbHop associated with the message is less than the maximum number of hops NbHopMax, the message may be retransmitted by the current node; otherwise the message is ignored. Alternatively, when the number of hops NbHop is initialized to a maximum number of hops, as long as the number of hops NbHop is not zero the message may be retransmitted by the current node; otherwise the message is ignored.

Each of the nodes may advantageously comprise a clock, in particular a synchronized clock. The clock makes it possible to implement a parameter that limits the lifetime of the message. In particular, the message may comprise an age AgeMsg. The decision to transmit or not transmit the message is made, in particular, based on the age of the message AgeMsg. More precisely, a lifetime AgeLimit is defined, carried by the message or specified in the current node. The age of the message AgeMsg is then compared to the lifetime AgeLimit. As long as the age of the message AgeMsg is less than the lifetime AgeLimit, the message may be retransmitted by the current node; otherwise, the message is ignored.

The message may also comprise a parameter relating to the urgency of the message. If the message is indicated as urgent, it may be processed by the current node according to a message priority protocol.

These parameters, namely the number of hops NbHop, the age of the message AgeMsg, and/or the urgency parameter of the message, may be initialized by the message sender or by the first node that sends the message in the main network.

In addition, the node may comprise a table of processed messages TabMsg. Thus, when a message is transmitted to the current node, if this message is identified as being among the processed messages, the message will be ignored by the node; otherwise it will be processed by the current node. This preliminary step prevents a node from processing the same message multiple times.

The table of processed messages may preferably have a fixed size, and implement a FIFO (“First In First Out”) type of operation. Alternatively, the table of processed messages may be cleared out according to the age of the processed messages, when the age of the message is accessible data. Other operations of the table of processed messages may be envisaged.

In the remainder of the description, a node will be described in more detail, it being possible to apply the described technical features to all nodes of the main network. The node is typically a small device that consumes little power.

The node comprises a processor PROC and a memory MEM storing at least the instructions of a computer program and accessible by the processor in order to implement the method as described above when the processor PROC executes the instructions of the program. The memory MEM of the node comprises, in particular, a random access memory and a storage memory.

The memory MEM of the node may in particular store the geographical location of the respective node.

Where appropriate, the node memory may store the table of processed messages, and/or additional constraint parameters such as the maximum number of hops NbHopMax, the message lifetime AgeLimit, or a parameter relating to the urgency of the message. The table of processed messages may in particular be stored in non-volatile memory of the node, namely flash memory or a hard disk, depending on network requirements.

Furthermore, the node comprises in particular a first communication interface COM1 controlled by the processor PROC, for receiving and transmitting messages from and to other nodes of the main network, in particular neighbouring nodes of the node in question. The first communication interface COM1 is controlled by the processor.

The node may comprise a second communication interface COM2 controlled by the processor PROC, for receiving and transmitting routing data from and to other nodes of the main network.

The first and second communication interfaces may in particular be the same.

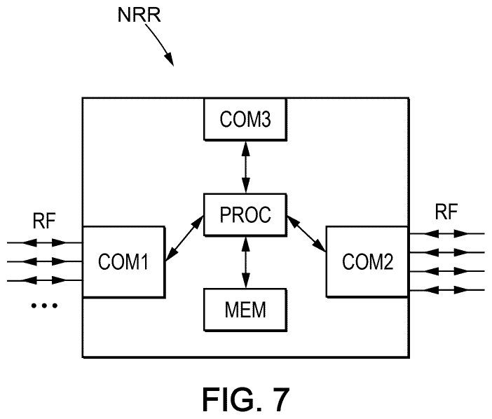

FIG. 7 illustrates an example of a routing-shortcut node NRR that may further comprise at least one additional communication interface COM3 controlled by the processor PROC, for receiving and transmitting data to and from other routing-shortcut nodes in the network, or to and from other networks to which the routing-shortcut node is connected.

A routing-shortcut node may comprise means for obtaining its geographical location.

Each of the first, second, or third communication interfaces COM1, COM2 and COM3 may preferably consist of a radiofrequency-based communication interface RF, enabling the nodes to communicate with each other without going through a central system. By way of non-limiting example, the communication interface may comply with 2G, 3G, 4G or 5G standards according to 3GPP. Low-power communication interfaces may in particular be preferred, such as Lora, BLE or SigFox. Other D2D (“Device to Device”) communication interfaces using 6G may also be considered in the future, provided that the cost and energy consumption constraints so allow.

In addition, at least some nodes may comprise external sensors that can generate messages to be transmitted over the main network (environmental sensors, meters).

Each node may also comprise power supply means, for example a battery, a wired power supply, solar panels, or a combination of these power supply means.

1. A routing method for routing a message via nodes of a mesh network, wherein the message comprises routing rationalization data the method being implemented by a node of the mesh network, and comprising:
upon receiving said message, selecting, at least on the basis of said routing rationalization data and of a network topology, a node to which to transmit said received message.

2. The routing method according to claim 1, wherein the routing rationalization data comprises an indication of a limitation on a number of hops to be provided for the message.

3. The routing method according to claim 1, wherein the routing rationalization data comprises geographical destination data for the message.

4. The routing method according to claim 1, wherein, when a node to which the received message is to be transmitted is selected, the method may comprise adjusting the number of hops remaining for the message.

5. The routing method according to claim 1, wherein, when the network topology allows the node receiving the message to communicate with a routing server selecting a node to which to transmit the message comprises transmitting the message to the routing server which is capable of selecting the node to which to transmit the message and of retransmitting the message to the selected node.

6. The routing method according to claim 1, wherein, when the network topology allows the node receiving the message to communicate via another network selecting a node to which to transmit the message comprises transmitting the message to the selected node via said other network (OtherNtw).

7. The routing method according to claim 6, wherein the method comprises a consultation of a routing table by the node receiving the message, in order to establish a route to the selected node via said other network

8. The routing method according to claim 1, wherein the node capable of selecting a node to which to transmit said received message, comprises additional communication means in comparison to other nodes of the network.

9. The routing method according to claim 1, comprising: obtaining respective current location data of at least two of said nodes capable of selecting a node to which to transmit said received message, and transmitting the message from a sending node to the receiving other node of said two nodes, if a distance between the respective current locations of the sending and receiving nodes is less than a second distance threshold.

10. The routing method according to claim 9, wherein at least some of the nodes which are capable of selecting a node to which to transmit said received message and from which the current location data is obtained, are mobile nodes.

11. The routing method according to claim 9, wherein the routing rationalization data comprises geographical destinationdata for the message, and wherein said mobile node stores the received message in a table of received messages upon reception, as long as the node is at a distance from the selected node that is greater than the second distance threshold.

12. A node of a network, configured to implement the method according to claim 1.

13. A non-transitory computer-readable medium storing instructions that, when executed by at least one processor, cause said at least one processor to implement the method according to claim 1.
